(19) United States
(12) Patent Application Publication
(10) Pub. No.: US 2026/0326681 A1
(43) Pub. Date: Oct. 22, 2026

(54) ENGINE ASSEMBLY AND WORK MACHINE

(71) Applicant: KAWASAKI MOTORS, LTD., Akashi-shi (JP)

(72) Inventors: Goki TAKANO, Akashi-shi (JP); Shiori KUSU, Akashi-shi (JP); Atsuya MIYAZAKI, Akashi-shi (JP)

(73) Assignee: KAWASAKI MOTORS, LTD., Akashi-shi (JP)

(21) Appl. No.: 19/649,301

(22) Filed: Apr. 16, 2026

(30) Foreign Application Priority Data
Apr. 22, 2025 (JP) 2025-070714

(51) Int. Cl. B60R 11/00; B60K 26/02; F02B 75/00; F02B 75/22; F02D 41/22; G07C 5/00

(52) U.S. Cl. CPC B60R 11/00; B60K 26/02; F02B 75/007; F02B 75/22; F02D 41/22; G07C 5/008; B60R 2011/0038; B60R 2011/0059

(57) ABSTRACT

An engine assembly includes: an internal combustion engine including a crankshaft extending in a vertical direction, at least one cylinder extending in a horizontal direction relative to the crankshaft, and a crankcase accommodating the crankshaft; an ECU including processing circuitry configured to control the internal combustion engine; a bracket fixed to the internal combustion engine; and a telematics control unit that is attached to the bracket and communicable with the processing circuitry.

### CROSS-REFERENCE TO RELATED APPLICATION

This application claims priority to and the benefit of Japanese Patent Application No. 2025-70714 filed on Apr. 22, 2025, the entire disclosure of which is incorporated herein by reference.

### BACKGROUND OF THE INVENTION

### Field of the Invention

The present disclosure relates to an engine assembly and a work machine.

### DESCRIPTION OF THE RELATED ART

Japanese Patent No. 3973095 discloses that a mobile phone for transmitting the operating state of an engine to the outside can be put into and taken out from the inside of an engine cover.

### SUMMARY OF THE INVENTION

According to Japanese Patent No. 3973095, a structure that allows the mobile phone to be put into and taken out from the inside of the engine cover is located at the engine cover. Therefore, the structure for arranging the mobile phone becomes complex, and the number of parts increases.

An object of one aspect of the present disclosure is to locate, with a simple configuration, a telematics control unit that can transmit operating information of an internal combustion engine to the outside.

An engine assembly according to one aspect of the present disclosure includes: an internal combustion engine including a crankshaft extending in a vertical direction, at least one cylinder extending in a horizontal direction relative to the crankshaft, and a crankcase accommodating the crankshaft; an ECU including processing circuitry configured to control the internal combustion engine; a bracket fixed to the internal combustion engine; and a telematics control unit that is attached to the bracket and communicable with the processing circuitry.

A work machine according to one aspect of the present disclosure includes: a frame; equipment supported by the frame; and an engine assembly supported by the frame. The engine assembly includes: an internal combustion engine including a crankshaft extending in a vertical direction, at least one cylinder extending in a horizontal direction relative to the crankshaft, and a crankcase accommodating the crankshaft; an ECU including processing circuitry configured to control the internal combustion engine; a bracket fixed to the internal combustion engine; and a telematics control unit that is attached to the bracket and communicable with the processing circuitry. The telematics control unit is located between the internal combustion engine and the equipment in a front-rear direction of the work machine.

A work machine according to another aspect of the present disclosure includes: a frame; equipment supported by the frame; an internal combustion engine supported by the frame; an ECU including processing circuitry configured to control the internal combustion engine; and a telematics control unit that is communicable with the processing circuitry. The telematics control unit is located between the internal combustion engine and the equipment in a front-rear direction of the work machine.

According to the engine assembly of the present disclosure, the TCU can be stably attached to the internal combustion engine with a simple configuration. According to the work machine of the present disclosure, foreign matter can be prevented from colliding with or becoming entangled with the TCU.

### BRIEF DESCRIPTION OF THE DRAWINGS

FIG. 1A is a side view of a lawn mower on which an engine assembly according to an embodiment is mounted.

FIG. 1B is a side view of the lawn mower as another example on which the engine assembly according to the embodiment is mounted.

FIG. 2 is a plan view of the engine assembly shown in FIG. 1.

FIG. 3 is a right side view of the engine assembly shown in FIG. 2.

FIG. 4 is a left side view of the engine assembly shown in FIG. 2.

FIG. 5 is a wiring diagram of the engine assembly shown in FIG. 3.

FIG. 6 is a rear perspective view of an attachment structure for a TCU shown in FIG. 3.

FIG. 7 is a front perspective view of the attachment structure for the TCU shown in FIG. 6.

FIG. 8 is a plan view of the attachment structure for the TCU shown in FIG. 6.

FIG. 9 is a sectional view taken along line VII-VII of FIG. 8.

### DETAILED DESCRIPTION

Hereinafter, an embodiment will be described with reference to the drawings.

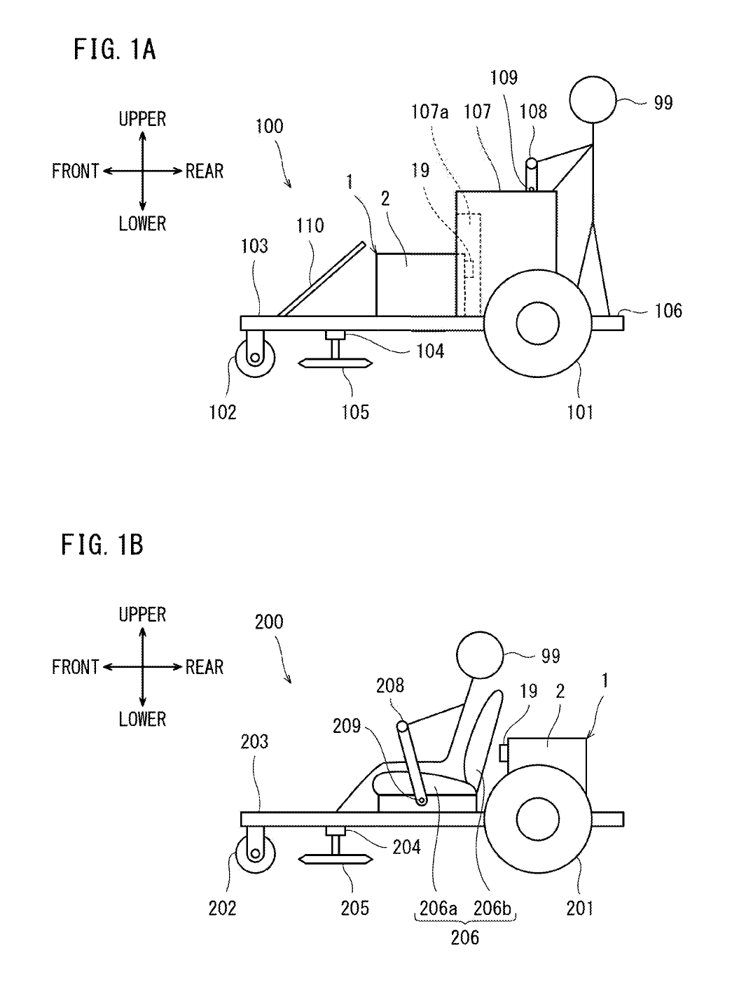

FIG. 1A is a side view of a lawn mower 100 on which an engine assembly 1 according to the embodiment is mounted. As shown in FIG. 1A, the lawn mower 100 is an example of a work machine including a work device. The lawn mower 100 is a stand-on lawn mower that is operated by a user 99 in a standing position. The lawn mower 100 includes wheels 101 and 102 and a frame 103 supported by the wheels 101 and 102. The frame 103 supports a rotating shaft 104 that drives a cutting blade 105. The rotating shaft 104 and the cutting blade 105 serve as the work device of the lawn mower 100.

A rear portion of the frame 103 supports a control platform 107. The control platform 107 is located on or above the frame 103. An operating portion 108 operated by the user 99 is located on an upper portion of the control platform 107. The operating portion 108 is, for example, an operating lever. However, the operating portion 108 may have other forms as long as it can change its operation amount. The operating portion 108 includes a user operation amount sensor 109 that detects a user operation amount with respect to the operating portion 108. A footrest 106 on which the user 99 stands is located on a portion of the frame 103 which is located behind the control platform 107.

The engine assembly 1 supported by the frame 103 is located in front of the control platform 107. The engine assembly 1 includes an internal combustion engine 2 and a below-described TCU 19 located behind the internal combustion engine 2. The internal combustion engine 2 drives the wheel 101 and also drives the rotating shaft 104 that drives the cutting blade 105. A below-described ECU 18 controls the internal combustion engine 2 such that driving force of the internal combustion engine 2 changes in accordance with the operation amount of the operating portion 108 which is detected by the user operation amount sensor 109. A cover 110 is located in front of the engine assembly 1. The cover 110 protects the engine assembly 1 from foreign matter, such as grass coming from front during traveling.

The TCU 19 is attached to the internal combustion engine 2 on one side, where the operating portion 108 exists, of the internal combustion engine 2 in a front-rear direction of the lawn mower 100. Since the operating portion 108 is located on a rear side of the internal combustion engine 2 in the front-rear direction of the lawn mower 100, the TCU 19 is attached to the internal combustion engine 2 from rear.

The TCU 19 is located between the internal combustion engine 2 and the control platform 107 in the front-rear direction of the lawn mower 100. When viewed from the front of the lawn mower 100, the TCU 19 is covered by the internal combustion engine 2 so as to be hidden by the internal combustion engine 2. When viewed from the rear of the lawn mower 100, the TCU 19 is covered by the control platform 107 so as to be hidden by the control platform 107. Conceptually, the control platform 107 is equipment of the lawn mower 100 which is located on or above the frame 103. To be specific, the TCU 19 is located between the internal combustion engine 2 and the equipment 107 of the lawn mower 100 in the front-rear direction of the lawn mower 100. Thus, foreign matter is prevented from colliding with or becoming entangled with the TCU 19.

Specifically, the control platform 107 includes a recessed space 107a that is open forward and recessed rearward. The TCU 19 is located in the recessed space 107a of the control platform 107. In a side view of the lawn mower 100, the TCU 19 is covered by the control platform 107. Thus, the foreign matter is further satisfactorily prevented from colliding with or becoming entangled with the TCU 19.

FIG. 1B is a side view of a lawn mower 200 as another example on which the engine assembly according to the embodiment is mounted. As shown in FIG. 1B, the lawn mower 200 is an example of the work machine including the work device. The lawn mower 200 is a sit-down lawn mower that is operated by the user 99 in a sitting position. The lawn mower 200 includes wheels 201 and 202 and a frame 203 supported by the wheels 201 and 202. The frame 203 supports a rotating shaft 204 that drives a cutting blade 205. The rotating shaft 204 and the cutting blade 205 serve as the work device of the lawn mower 200.

The frame 203 supports a seat 206 on which the user 99 is seated. The seat 206 is located on or above the frame 203. The seat 206 includes a seat portion 206a and a backrest portion 206b. The seat portion 206a supports the buttocks of the user 99 from below. The backrest portion 206b projects upward from a rear end portion of the seat portion 206a and supports the back of the user 99 from behind. The lawn mower 200 includes an operating portion 208 operated by the user 99 seated on the seat 206. The operating portion 208 is, for example, an operating lever. However, the operating portion 208 may have other forms as long as it can change its operation amount. The operating portion 208 includes a user operation amount sensor 209 that detects a user operation amount with respect to the operating portion 208.

The engine assembly 1 is located behind the seat 206. The engine assembly 1 includes the internal combustion engine 2 and the below-described TCU 19 located in front of the internal combustion engine 2. The below-described ECU 18 controls the internal combustion engine 2 such that the driving force of the internal combustion engine 2 changes in accordance with the operation amount of the operating portion 208 which is detected by the user operation amount sensor 209.

The TCU 19 is attached to the internal combustion engine 2 on one side, where the operating portion 208 exists, of the internal combustion engine 2 in the front-rear direction of the lawn mower 200. Since the operating portion 208 is located in front of the internal combustion engine 2 in the front-rear direction of the lawn mower 200, the TCU 19 is attached to the internal combustion engine 2 from the front.

The TCU 19 is located between the seat 206 and the internal combustion engine 2 in the front-rear direction of the lawn mower 200. When viewed from the front of the lawn mower 200, the TCU 19 is covered by the seat 206 so as to be hidden by the seat 206. When viewed from the rear of the lawn mower 200, the TCU 19 is covered by the internal combustion engine 2 so as to be hidden by the internal combustion engine 2. Conceptually, the seat 206 is equipment of the lawn mower 200 which is located on or above the frame 203. To be specific, the TCU 19 is located between the internal combustion engine 2 and the equipment 206 of the lawn mower 200 in the front-rear direction of the lawn mower 200. Thus, the foreign matter is prevented from colliding with or becoming entangled with the TCU 19.

Instead of the lawn mower, the work machine including the work device may be a wheel loader, a snow removal vehicle, an agricultural machine, or the like. The work device of the wheel loader may be a bucket. The work device of the snow removal vehicle may be a rotary snow blower. The work device of the agricultural machine may be, for example, a seedling planting device, a harvesting device, or the like.

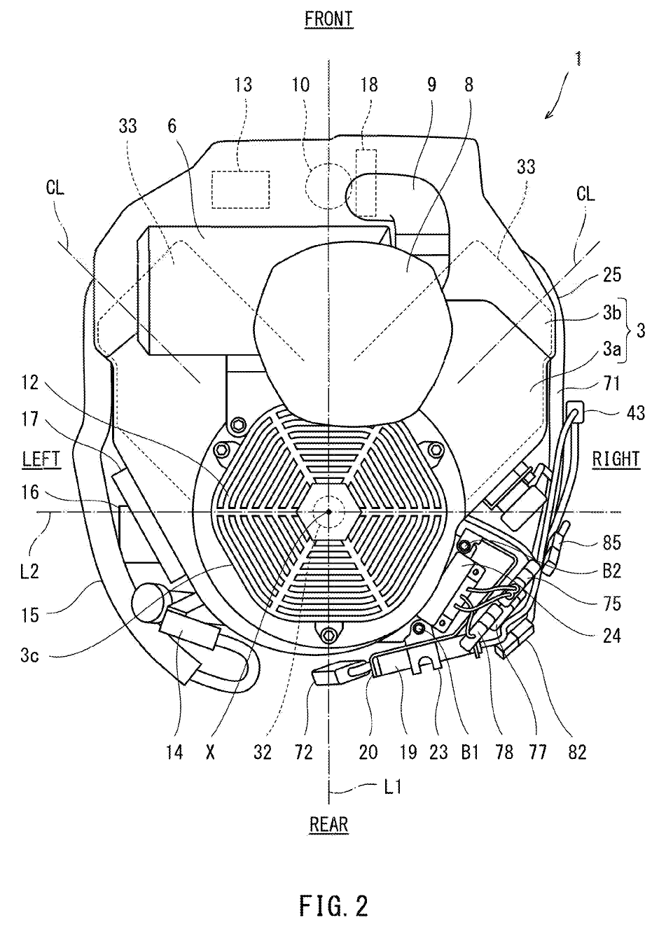

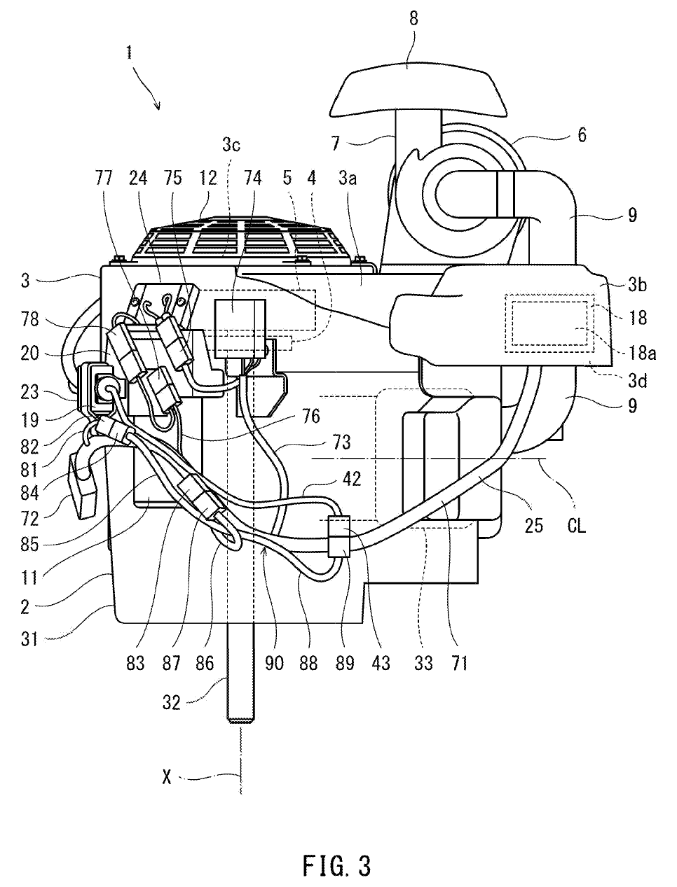

FIG. 2 is a plan view of the engine assembly 1 shown in FIG. 1. FIG. 3 is a right side view of the engine assembly 1 shown in FIG. 2. As one example, directions of the engine assembly 1 are described based on directions of the lawn mower 100 on which the engine assembly 1 is mounted. As shown in FIGS. 2 and 3, the engine assembly 1 includes the internal combustion engine 2 that is a reciprocating engine. The internal combustion engine 2 includes a crankcase 31, a crankshaft 32, and a pair of cylinders 33. The internal combustion engine 2 is, for example, a V-twin engine but may be a single-cylinder engine.

The crankshaft 32 is accommodated in the crankcase 31 while being rotatably supported by the crankcase 31. A rotation axis X of the crankshaft 32 extends in a vertical direction. The crankshaft 32 projects downward from the crankcase 31. The crankshaft 32 rotates in association with pistons that reciprocate in the cylinders 33 along center lines CL of the cylinders 33. The center lines CL of the cylinders 33 extend in a horizontal direction.

The cylinders 33 project in a V shape relative to the crankshaft 32. In the plan view, the cylinders 33 are symmetrically located with respect to a reference line that is a first imaginary straight line L1 passing through the rotation axis X of the crankshaft 32. The first imaginary straight line L1 extends in the front-rear direction of the engine assembly 1. The cylinders 33 are located in front of a second imaginary straight line L2 that passes through the rotation axis X of the crankshaft 32 and is perpendicular to the first imaginary straight line L1.

The engine assembly 1 includes an upper cover 3 that is fixed to the crankcase 31 while covering the crankcase 31 from above. The upper cover 3 has an inverted U-shaped cross section that is open downward. The upper cover 3 defines an internal space between the upper cover 3 and the crankcase 31. An upper portion of the crankshaft 32 projecting upward from the crankcase 31 is located in the internal space of the upper cover 3. A power generator 4 and a cooling fan 5 are located above the internal combustion engine 2 and in the internal space of the upper cover 3.

The power generator 4 and the cooling fan 5 are attached to the upper portion of the crankshaft 32. The power generator 4 generates electric power in mechanical association with the crankshaft 32. The electric power generated by the power generator 4 is charged to a battery of the lawn mower 100 and is used as electric power to be supplied to a starter motor 11 for starting the internal combustion engine 2 and an accessory electric component of the lawn mower 100. The cooling fan 5 rotates in mechanical association with the crankshaft 32.

The upper cover 3 includes: a crank cover portion 3a that covers the crankcase 31 from above; and an electric component cover portion 3b that covers the below-described ECU 18 and throttle equipment 10 from above. The power generator 4 and the cooling fan 5 are covered by the crank cover portion 3a of the upper cover 3 from above.

An upper plate portion of the crank cover portion 3a of the upper cover 3 includes an inflow opening 3c in which outside air flows. A fan cover 12 is detachably attached to the upper cover 3 so as to cover the inflow opening 3c. The fan cover 12 has a mesh structure that allows air to pass therethrough while preventing foreign matter from passing therethrough.

A space defined by the crank cover portion 3a and a space defined by the electric component cover portion 3b are partitioned and isolated from each other. The electric component cover portion 3b of the upper cover 3 is open downward with respect to a space located outside the crankcase 31. When the cooling fan 5 rotates in association with the crankshaft 32, air is drawn in through the fan cover 12 and the inflow opening 3c, and the drawn air cools the power generator 4 and the internal combustion engine 2 and is then discharged to the outside.

The engine assembly 1 includes an air cleaner 6 that purifies intake air to be supplied to the internal combustion engine 2. The air cleaner 6 is located above the upper cover 3. An intake duct 7 projects upward from the air cleaner 6. The intake duct 7 includes an intake port at an upper end thereof. The intake port of the intake duct 7 is covered by an intake cover 8 from above while leaving a gap that allows air to flow therethrough. The outside air drawn in through the intake port of the intake duct 7 is purified by the air cleaner 6.

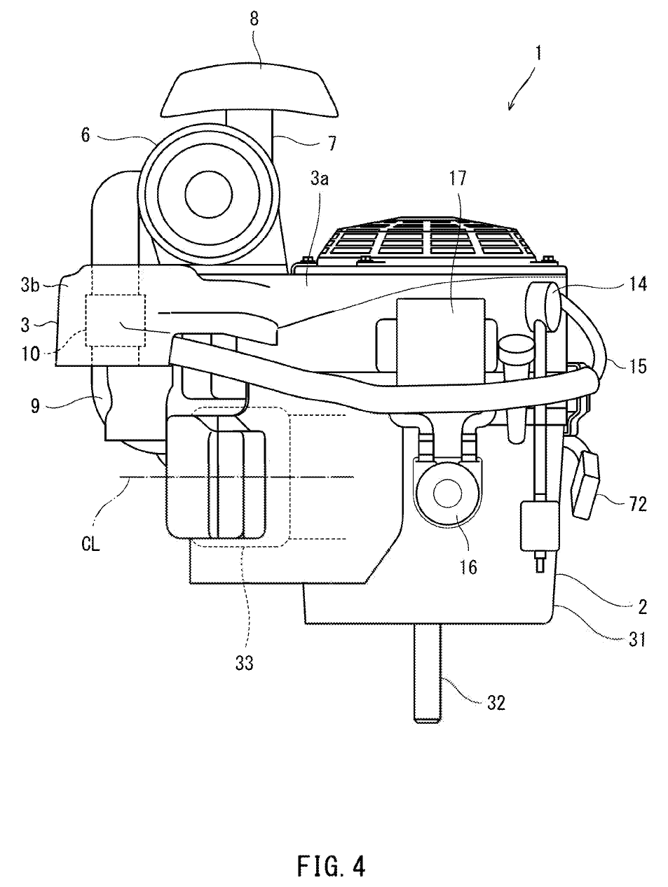

FIG. 4 is a left side view of the engine assembly 1 shown in FIG. 2. As shown in FIGS. 3 and 4, the air purified by the air cleaner 6 flows through an intake pipe 9 connected to the air cleaner 6. The throttle equipment 10 including a throttle valve is interposed in the intake pipe 9. A fuel injector that supplies fuel to an intake passage is attached to the intake pipe 9 or the throttle equipment 10. As shown in FIG. 2, in the plan view, the throttle equipment 10 is located on the first imaginary straight line L1. In the plan view, the throttle equipment 10 is located in front of the second imaginary straight line L2.

As shown in FIGS. 2 and 4, the engine assembly 1 includes a first fuel pump 13 and a second fuel pump 14 which are located on a left side of the first imaginary straight line L1 in the plan view. A fuel tube 15 that connects the first fuel pump 13 to the second fuel pump 14 is also located on the left side of the first imaginary straight line L1. Specifically, in the plan view, the first fuel pump 13 is located in front of the second imaginary straight line L2. In the plan view, the second fuel pump 14 is located behind the second imaginary straight line L2.

The second fuel pump 14 draws the fuel from a fuel tank. The first fuel pump 13 is connected to the fuel injector that supplies the fuel to the cylinders 33. The first fuel pump 13 pressurizes the fuel supplied from the second fuel pump 14 through the fuel tube 15, and supplies the fuel to the fuel injector.

The engine assembly 1 includes an oil filter 16 and an oil cooler 17 which are located on the left side of the first imaginary straight line L1 in the plan view. The oil filter 16 and the oil cooler 17 are located on a left side surface of the crankcase 31. The oil filter 16 filters oil that lubricates the internal combustion engine 2. The oil cooler 17 cools the oil that has been filtered by the oil filter 16.

As shown in FIGS. 2 and 3, the engine assembly 1 includes the ECU 18 that is an electronic control unit that controls the internal combustion engine 2. The ECU 18 includes processing circuitry 18a. The ECU 18 is located adjacent to the throttle equipment 10. In the plan view, the ECU 18 is located in front of the second imaginary straight line L2.

The engine assembly 1 includes the TCU 19 that is a telematics control unit that is communicable with the ECU 18. The TCU 19 is connected to a network, such as the Internet, through wireless communication in accordance with a request from the ECU 18 and performs bidirectional communication with an external information processing apparatus, such as a server. The TCU 19 is attached to a bracket 20 fixed to the internal combustion engine 2. Since the TCU 19 is attached to the bracket 20 fixed to the internal combustion engine 2, the TCU 19 is stably attached to the internal combustion engine 2 with a simple configuration.

The TCU 19 is located behind the second imaginary straight line L2. Since the TCU 19 is located on an opposite side to a side where the cylinders 33 exist, in a direction along the first imaginary straight line L1, heat of the cylinders 33 is less likely to be transferred to the TCU 19.

The TCU 19 is located on a right side of the first imaginary straight line L1. Since the TCU 19 is located on an opposite side to a side where the fuel pumps 13 and 14 exist, in the direction along the second imaginary straight line L2, a place where an electric system including the TCU 19 is located and a place where a fuel system including the fuel pumps 13 and 14 is located are spatially separated from each other, and this can improve the safety.

An upper end of the TCU 19 is located higher than the center lines CL of the cylinders 33. In the present embodiment, a lower end of the TCU 19 is also located higher than the center lines CL of the cylinders 33. Thus, the user can easily access the TCU 19 from above. The upper end of the TCU 19 is located lower than an upper surface of the upper cover 3. Thus, foreign matter is less likely to hit the TCU 19.

The engine assembly 1 includes the starter motor 11 that can drive the crankshaft 32. The starter motor 11 is located on a lateral side of the crankcase 31 and vertically under the bracket 20.

The engine assembly 1 includes a wire harness 25 connected to the ECU 18. The wire harness 25 is located on the right side of the internal combustion engine 2. The wire harness 25 includes a main line 71 that is located on the right side of the internal combustion engine 2 and extends in the front-rear direction. A main connector 72 located behind the internal combustion engine 2 is attached to a tip of the main line 71.

The wire harness 25 includes a first sub line 73 extending from the main line 71. A first relay box 74 is connected to the first sub line 73. A first connector 75 connects a regulator 24 to the power generator 4. The regulator 24 is located on a side surface of the upper cover 3.

The regulator 24 is connected to the starter motor 11 through a second sub line 76 in which a second connector 78 and a second fuse 77 are interposed. The regulator 24 is connected to the battery through the starter motor 11.

The wire harness 25 includes a first diagnostic communication line 81 extending from the main line 71. The first diagnostic communication line 81 is a communication line for diagnosing the engine assembly 1 by communicating with the ECU 18 using a diagnostic tool that is software installed to an external information processing terminal 95. A first diagnostic connector 82 is attached to a tip of the first diagnostic communication line 81. In diagnostic work, when a connector 96 connected to the information processing terminal 95 is connected to the first diagnostic connector 82, the information processing terminal 95 can communicate with the ECU 18.

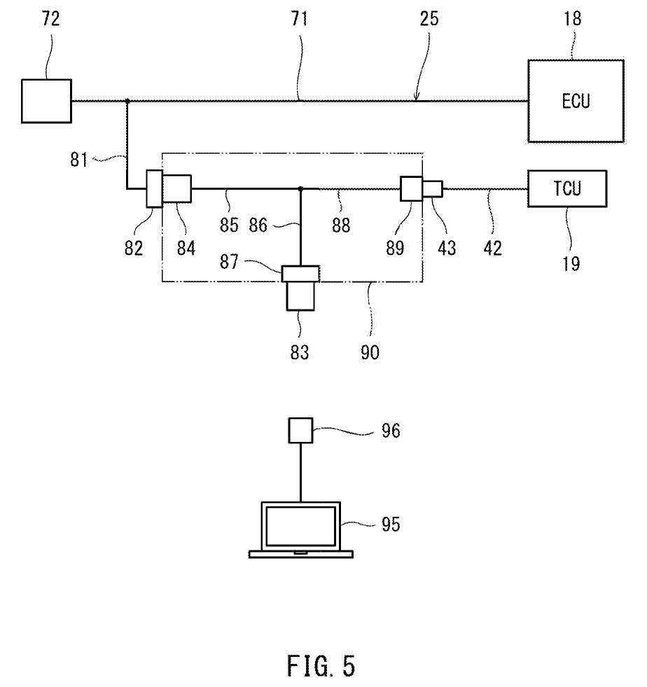

FIG. 5 is a wiring diagram of the engine assembly 1 shown in FIG. 3. As shown in FIGS. 3 and 5, in the present embodiment, an additional harness 90 is used so that the first diagnostic connector 82 is used for diagnosis and for the TCU 19. The additional harness 90 includes a relay connector 84, a second diagnostic communication line 85, a third diagnostic communication line 86, a second diagnostic connector 87, a branch communication line 88, and a branch connector 89.

The relay connector 84 is detachably coupled to the first diagnostic connector 82. The second diagnostic communication line 85 is connected to the relay connector 84 and is electrically connected to the first diagnostic communication line 81. The third diagnostic communication line 86 is an extended line of the second diagnostic communication line 85. The second diagnostic connector 87 is connected to the third diagnostic communication line 86. The branch communication line 88 extends from the second diagnostic communication line 85. The branch connector 89 is connected to the branch communication line 88. A TCU connector 43 connected to a TCU communication line 42 of the TCU 19 is detachably coupled to the branch connector 89. Thus, communication between the ECU 18 and the TCU 19 is realized using the first diagnostic communication line 81.

A dummy connector 83 is detachably coupled to the second diagnostic connector 87. In the diagnostic work, when the dummy connector 83 is detached from the second diagnostic connector 87, and the connector 96 connected to the information processing terminal 95 is coupled to the second diagnostic connector 87, the information processing terminal 95 can communicate with the ECU 18.

When the TCU 19 is omitted, the additional harness 90 is unnecessary. Therefore, when the connector 96 connected to the information processing terminal 95 is coupled to the first diagnostic connector 82, the information processing terminal 95 can communicate with the ECU 18. Moreover, the wire harness 25 may include a communication line for the TCU 19 separately from the first diagnostic communication line 81.

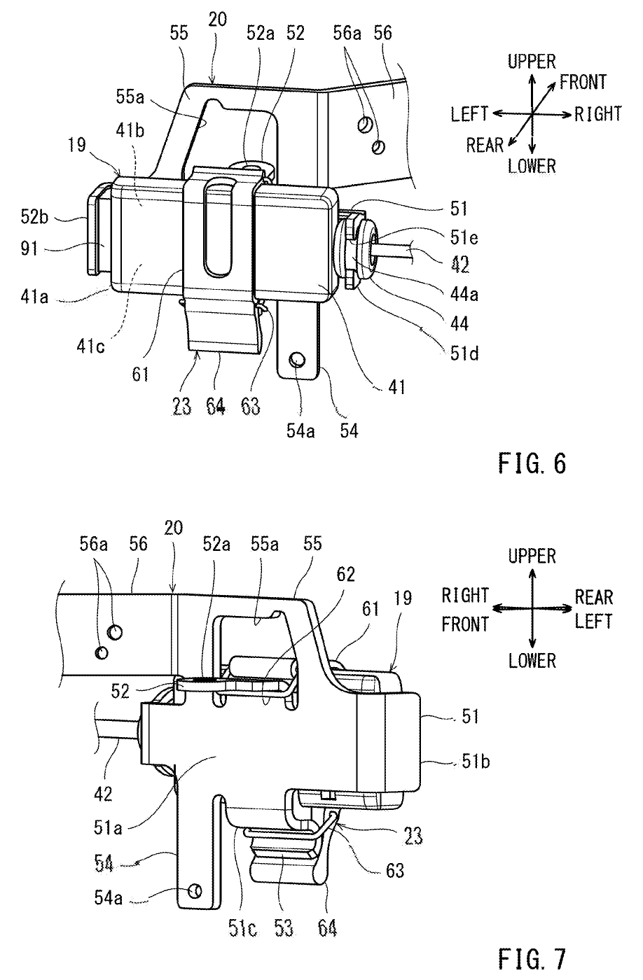

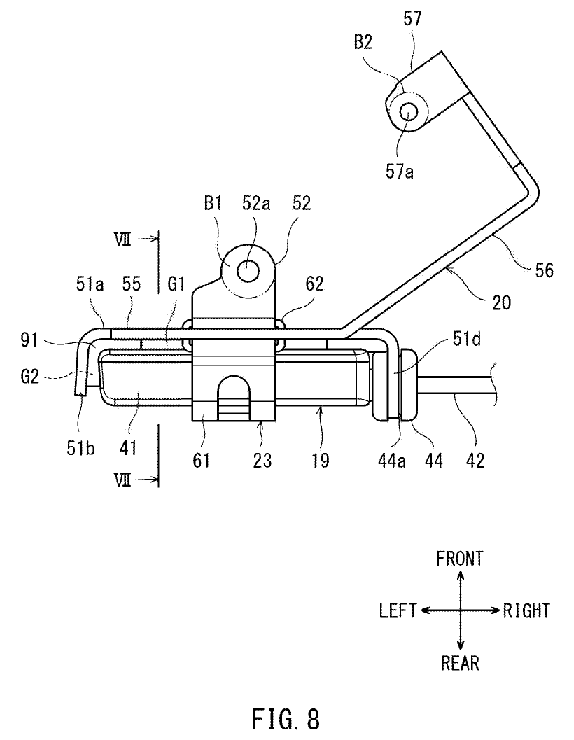

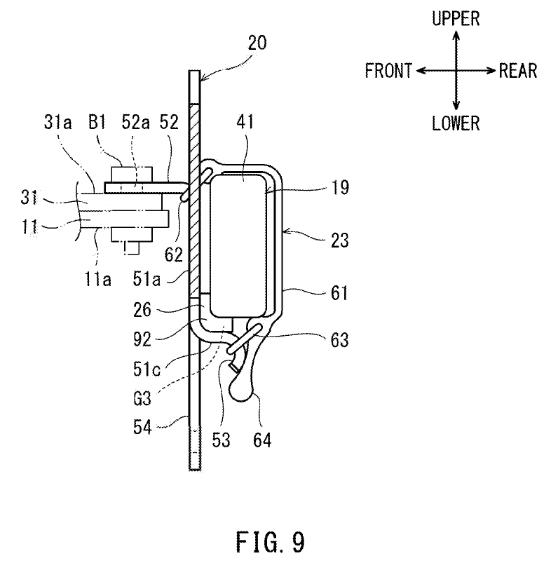

FIG. 6 is a rear perspective view of an attachment structure for the TCU 19 shown in FIGS. 3, 7. is a front perspective view of the attachment structure for the TCU 19 shown in FIGS. 6 , 8. is a plan view of the attachment structure for the TCU 19 shown in FIGS. 6, 9. is a sectional view taken along line VII-VII of FIG. 8. As shown in FIGS. 6-8, the TCU 19 includes a TCU main body 41, the TCU communication line 42, and a grommet 44. The TCU main body 41 includes a case 41a, a circuit board 41b accommodated in the case 41a, and an antenna 41c accommodated in the case 41a and connected to the circuit board 41b. The TCU main body 41 has a rectangular parallelepiped shape that is long in a horizontal direction.

The TCU communication line 42 is led out from the case 41a to the right while being connected to the circuit board 41b. A portion of the TCU communication line 42 which is adjacent to the case 41a is covered by the grommet 44. The TCU 19 does not have to be located in an orientation extending in the horizontal direction and may be located in an orientation extending in the vertical direction.

The TCU 19 is attached to the bracket 20. The bracket 20 is a metal bracket. The bracket 20 includes a TCU support plate portion 51, a first attachment plate portion 52, a locking plate portion 53, an electric wire support portion 54, a hook loop plate portion 55, a connector support plate portion 56, and a second attachment plate portion 57.

The TCU support plate portion 51 extends in the vertical direction such that the TCU 19 is overlapped with the TCU support plate portion 51 from the rear. The TCU support plate portion 51 includes a first support plate portion 51a, a second support plate portion 51b, a third support plate portion 51c, and a fourth support plate portion 51d. The first support plate portion 51a is opposed to a front surface of the TCU 19. The second support plate portion 51b is bent and projects from the first support plate portion 51a, i.e., projects rearward from a left end of the first support plate portion 51a. The second support plate portion 51b is opposed to a left surface of the TCU 19.

The third support plate portion 51c is bent and projects from the first support plate portion 51a, i.e., projects forward from a middle portion of a lower end of the first support plate portion 51a. The third support plate portion 51c is opposed to a lower surface of the TCU 19. The fourth support plate portion 51d is bent and projects from the first support plate portion 51a, i.e., projects rearward from a right end of the first support plate portion 51a. The fourth support plate portion 51d includes a C-shaped locking portion 51e fitted to an annular groove 44a of an outer periphery of the grommet 44.

The first attachment plate portion 52 projects forward in the horizontal direction from a portion of an upper end of the first support plate portion 51a. The first attachment plate portion 52 includes a bolt hole 52a. The locking plate portion 53 is connected to the TCU support plate portion 51 and extends downward and forward from a tip of the third support plate portion 51c. The locking plate portion 53 has a hook shape that is convex rearward. The electric wire support portion 54 projects downward from another portion of the lower end of the first support plate portion 51a. The electric wire support portion 54 includes a locking hole 54a to which a clamp is locked. The clamp is attached to the main line 71 of the wire harness 25 to support the main line 71. The locking hole 54a serves as a support portion for the clamp that supports the main line 71 of the wire harness 25.

The hook loop plate portion 55 projects upward from the upper end of the first support plate portion 51a. The hook loop plate portion 55 lies in the same plane as the first support plate portion 51a. The hook loop plate portion 55 includes an opening 55a that is open in the front-rear direction. When lifting the engine assembly 1 upward, a hook of a crane or a hand of an operator is inserted into the opening 55a of the hook loop plate portion 55.

The connector support plate portion 56 extends rightward and forward from a right end of the hook loop plate portion 55. The connector support plate portion 56 extends in the vertical direction. The connector support plate portion 56 includes locking holes 56a to which clamps located on the first connector 75, the second fuse 77, and the second connector 78 are locked. The locking holes 56a serve as support portions that support the first connector 75, the second fuse 77, and the second connector 78.

As shown in FIG. 8, the connector support plate portion 56 has an L shape in the plan view. The second attachment plate portion 57 projects in the horizontal direction from a portion of an upper end of the connector support plate portion 56. The second attachment plate portion 57 includes a bolt hole 57a.

As above, since the bracket 20 is also used for purposes other than the purpose of attaching the TCU 19, the increase in the number of parts for the TCU 19 is suppressed.

The TCU 19 is attached to the bracket 20 by a band 23. The band 23 includes a band main body portion 61, a loop portion 62, a locking portion 63, and a holding portion 64. The band main body portion 61 is a band-shaped body having elasticity. The loop portion 62 is an annular body connected to one end portion of the band main body portion 61. The locking portion 63 is connected to the other end portion of the band main body portion 61. The locking portion 63 may have any shape that is lockable to the locking plate portion 53 of the bracket 20. In the present embodiment, the locking portion 63 is a loop portion that is an annular body. The holding portion 64 is adjacent to the locking portion 63 and projects from the band main body portion 61.

The operator holds the band 23 with his/her hand, inserts the first attachment plate portion 52 of the bracket 20 into the loop portion 62, and positions the loop portion 62 between the bolt hole 52a of the first attachment plate portion 52 and the TCU support plate portion 51. In this state, the operator inserts a first bolt B1, which is an example of a fastener, into the bolt hole 52a of the first attachment plate portion 52, and fastens the first attachment plate portion 52 of the bracket 20 to the crankcase 31. Thus, the first bolt B1 prevents the loop portion 62 of the band 23 from coming off from the first attachment plate portion 52 of the bracket 20.

The first attachment plate portion 52 of the bracket 20 is fastened to a flange 31a of the crankcase 31 together with a flange 11a of the starter motor 11. Thus, when fastening the bracket 20 to the crankcase 31, the increase in the number of parts and the increase in the occupied space are suppressed. Moreover, a second bolt B2 is inserted into the bolt hole 57a of the second attachment plate portion 57 and fastens the second attachment plate portion 57 of the bracket 20 to the crankcase 31.

The operator sandwiches the TCU 19 between the first support plate portion 51a and the band main body portion 61 and hooks the locking portion 63 of the band 23 onto the locking plate portion 53 of the bracket 20. When detaching the band 23, the operator pinches the holding portion 64 of the band 23 with fingers and pulls it, and separates the locking portion 63 from the locking plate portion 53 while stretching the band main body portion 61.

A non-conductive elastic body 26 is located between the TCU 19 and the bracket 20. The elastic body 26 is made of rubber or elastomer. The elastic body 26 is sandwiched between the TCU 19 and the bracket 20 with the TCU 19 spaced apart from the bracket 20. Since the non-conductive elastic body 26 serves as a spacer, the TCU 19 is spaced apart from the bracket 20 made of metal. Therefore, the wireless communication of the TCU 19 stabilizes.

The elastic body 26 includes a first elastic portion 91 and a second elastic portion 92. The first elastic portion 91 is located in a bent state along a corner portion between the first support plate portion 51a and the second support plate portion 51b. Thus, the first elastic portion 91 is located in a first gap G1 between the first support plate portion 51a and the TCU 19 and a second gap G2 between the second support plate portion 51b and the TCU 19.

The second elastic portion 92 is located in a bent state along a corner portion between the first support plate portion 51a and the third support plate portion 51c. Thus, the second elastic portion 92 is located in the first gap G1 between the first support plate portion 51a and the TCU 19 and a third gap G3 between the third support plate portion 51c and the TCU 19. Vibrations of the TCU 19 in all three directions can be absorbed by the first elastic portion 91 and the second elastic portion 92.

The foregoing has described the embodiment as an example of the technology disclosed in the present application. However, the technology in the present disclosure is not limited to this and is applicable to embodiments in which modifications, replacements, additions, omissions, and the like have been suitably made. Moreover, a new embodiment may be prepared by combining the components described in the above embodiment. For example, some of components or methods in one embodiment may be applied to another embodiment. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

The functionality of the elements disclosed herein may be implemented using circuitry or processing circuitry which includes general purpose processors, special purpose processors, integrated circuits, ASICs (Application Specific Integrated Circuits), FPGAs (Field Programmable Gate Arrays), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

### Aspects

The above embodiment describes specific examples of the following aspects.

### First Aspect

An engine assembly including:
an internal combustion engine including
   a crankshaft extending in a vertical direction,
   at least one cylinder extending in a horizontal direction relative to the crankshaft, and
   a crankcase accommodating the crankshaft;
an ECU including processing circuitry configured to control the internal combustion engine;
a bracket fixed to the internal combustion engine; and
a telematics control unit that is attached to the bracket and communicable with the processing circuitry.

According to the first aspect, since the TCU (telematics control unit) is attached to the bracket fixed to the internal combustion engine, the TCU can be stably attached to the internal combustion engine with a simple configuration.

### Second Aspect

The engine assembly according to the first aspect, further including a starter motor that drives the crankshaft, wherein

the bracket is fastened to the crankcase together with the starter motor by a fastener.

According to the second aspect, when fastening the bracket to the crankcase, the increase in the number of parts and the increase in the occupied space can be suppressed.

### Third Aspect

The engine assembly according to the first or second aspect, wherein:
the at least one cylinder includes a pair of cylinders that project in a V shape relative to the crankshaft so as to be symmetrically located with respect to a reference line that is a first imaginary straight line passing through a rotation axis of the crankshaft in a plan view; and
in the plan view, the pair of cylinders are located on one side of a second imaginary straight line that passes through the rotation axis of the crankshaft and is perpendicular to the first imaginary straight line, and the telematics control unit is located on the other side of the second imaginary straight line.

According to the third aspect, since the TCU is located on an opposite side to the cylinder in the direction along the first imaginary straight line, the heat of the cylinder is less likely to be transferred to the TCU. Therefore, the heat resistance requirement of the TCU can be relaxed.

### Fourth Aspect

The engine assembly according to any one of the first to third aspects, further including at least one fuel pump that supplies fuel to the cylinder, wherein:
the at least one cylinder includes a pair of cylinders that project in a V shape relative to the crankshaft so as to be symmetrically located with respect to a reference line that is a first imaginary straight line passing through a rotation axis of the crankshaft in a plan view; and
in the plan view, the fuel pump is located on one side of the first imaginary straight line, and the telematics control unit is located on the other side of the first imaginary straight line.

According to the fourth aspect, since the telematics control unit is located on an opposite side to the fuel pump in a direction perpendicular to the first imaginary straight line in the plan view, a place where an electric system including the telematics control unit is located and a place where a fuel system including the fuel pump is located are spatially separated from each other, and this improves the ease of maintenance.

### Fifth Aspect

The engine assembly according to any one of the first to fourth aspects, wherein an upper end of the telematics control unit is located higher than a center line of the cylinder.

According to the fifth aspect, the user can easily access the TCU from above, and this improves the ease of maintenance.

### Sixth Aspect

The engine assembly according to any one of the first to fifth aspects, wherein the bracket includes a hook loop for lifting the engine assembly upward.

According to the sixth aspect, since the bracket for lifting the engine assembly upward also serves as a component for attaching the TCU, the increase in the number of parts for the TCU can be suppressed.

### Seventh Aspect

The engine assembly according to any one of the first to sixth aspects, wherein the bracket includes a support portion that supports an electric wire or a connector attached to the electric wire.

According to the seventh aspect, since the bracket for attaching the electric wire or the connector serves as a component for attaching the TCU, the increase in the number of parts for the TCU can be suppressed.

### Eighth Aspect

The engine assembly according to any one of the first to seventh aspects, further including:
a band that attaches the telematics control unit to the bracket and includes
   a band main body portion,
   a loop portion connected to one end portion of the band main body portion, and
   a locking portion connected to the other end portion of the band main body portion; and
a bolt that fixes the bracket to the internal combustion engine, wherein:
the bracket includes
   a TCU support plate portion with which the telematics control unit is overlapped,
   an attachment plate portion that projects from the TCU support plate portion toward one side in the horizontal direction and includes a bolt hole, and
   a locking plate portion connected to the TCU support plate portion;
the telematics control unit is sandwiched between the TCU support plate portion and the band main body portion with the attachment plate portion inserted into the loop portion and with the locking portion detachably locked to the locking plate portion; and
the bolt fastens the attachment plate portion to the internal combustion engine through the bolt hole with the attachment plate portion of the bracket inserted into the loop portion and with the loop portion located between the bolt hole and the TCU support plate portion.

According to the eighth aspect, since the bolt prevents the loop portion of the band from coming off from the attachment plate portion of the bracket, convenience during maintenance improves.

### Ninth Aspect

The engine assembly according to any one of the first to eighth aspects, further including a non-conductive elastic body sandwiched between the bracket and the telematics control unit with the telematics control unit spaced apart from the bracket, wherein:
the bracket includes a metal bracket including a TCU support plate portion with which the telematics control unit is overlapped;
the TCU support plate portion includes
   a first support plate portion which extends in the vertical direction and with which the telematics control unit is overlapped in the horizontal direction,
   a second support plate portion that is bent and projects from the first support plate portion, and
   a third support plate portion that is bent and projects from the first support plate portion; and
the elastic body is located, in a bent state, along a corner portion between the first support plate portion and the second support plate portion, and is located, in a bent state, along a corner portion between the first support plate portion and the third support plate portion, such that the elastic body is located in:
   (i) a first gap between the first support plate portion and the telematics control unit;
   (ii) a second gap between the second support plate portion and the telematics control unit; and
   (iii) a third gap between the third support plate portion and the telematics control unit.

According to the ninth aspect, vibrations in three directions can be absorbed by the elastic body. Moreover, since the non-conductive elastic body serves as a spacer, the TCU is spaced apart from the metal bracket. Thus, the wireless communication of the TCU can be stabilized.

### Tenth Aspect

The engine assembly according to any one of the first to ninth aspects, further including:
a diagnostic communication line for a diagnostic tool connected to the ECU;
a branch communication line extending from the diagnostic communication line; and
a branch connector connected to the branch communication line, wherein:
   the telematics control unit includes
      a TCU main body including a circuit board,
      a TCU communication line led out from the TCU main body, and
      a TCU connector connected to the TCU communication line; and
   the TCU connector is coupled to the branch connector.

According to the tenth aspect, since communication between the ECU and the TCU can be realized using the diagnostic communication line, wiring can be simplified.

### Eleventh Aspect

A work machine including:
a frame;
equipment supported by the frame; and
an engine assembly supported by the frame, wherein:
   the engine assembly includes
      an internal combustion engine including
         a crankshaft extending in a vertical direction,
         at least one cylinder extending in a horizontal direction relative to the crankshaft, and
         a crankcase accommodating the crankshaft,
      an ECU including processing circuitry configured to control the internal combustion engine,
      a bracket fixed to the internal combustion engine, and
      a telematics control unit that is attached to the bracket and communicable with the processing circuitry; and
   the telematics control unit is located between the internal combustion engine and the equipment in a front-rear direction of the work machine.

According to the eleventh aspect, foreign matter can be prevented from colliding with or becoming entangled with the telematics control unit.

### Twelfth Aspect

A work machine including:
a frame;
equipment supported by the frame;
an internal combustion engine supported by the frame;
an ECU including processing circuitry configured to control the internal combustion engine; and
a telematics control unit that is communicable with the processing circuitry, wherein
the telematics control unit is located between the internal combustion engine and the equipment in a front-rear direction of the work machine.

According to the twelfth aspect, foreign matter can be prevented from colliding with or becoming entangled with the telematics control unit.

### Thirteenth Aspect

The work machine according to the twelfth aspect, wherein the equipment includes a control platform or a seat on which a user is seated, the control platform including an operating portion operated by the user.

According to the thirteenth aspect, the telematics control unit can be protected by utilizing the control platform or the seat of the work machine.

What is claimed is:

1. An engine assembly comprising:
an internal combustion engine including
a crankshaft extending in a vertical direction,
at least one cylinder extending in a horizontal direction relative to the crankshaft, and
a crankcase accommodating the crankshaft;
an ECU including processing circuitry configured to control the internal combustion engine;
a bracket fixed to the internal combustion engine; and
a telematics control unit that is attached to the bracket and communicable with the processing circuitry.

2. The engine assembly according to claim 1, further comprising a starter motor that drives the crankshaft, wherein
the bracket is fastened to the crankcase together with the starter motor by a fastener.

3. The engine assembly according to claim 1, wherein:
the at least one cylinder comprises a pair of cylinders that project in a V shape relative to the crankshaft so as to be symmetrically located with respect to a reference line that is a first imaginary straight line passing through a rotation axis of the crankshaft in a plan view; and
in the plan view, the pair of cylinders are located on one side of a second imaginary straight line that passes through the rotation axis of the crankshaft and is perpendicular to the first imaginary straight line, and the telematics control unit is located on the other side of the second imaginary straight line.

4. The engine assembly according to claim 1, further comprising at least one fuel pump that supplies fuel to the cylinder, wherein:
the at least one cylinder comprises a pair of cylinders that project in a V shape relative to the crankshaft so as to be symmetrically located with respect to a reference line that is a first imaginary straight line passing through a rotation axis of the crankshaft in a plan view; and
in the plan view, the fuel pump is located on one side of the first imaginary straight line, and the telematics control unit is located on the other side of the first imaginary straight line.

5. The engine assembly according to claim 1, wherein an upper end of the telematics control unit is located higher than a center line of the cylinder.

6. The engine assembly according to claim 1, wherein the bracket includes a hook loop for lifting the engine assembly upward.

7. The engine assembly according to claim 1, wherein the bracket includes a support portion that supports an electric wire or a connector attached to the electric wire.

8. The engine assembly according to claim 1, further comprising:
a band that attaches the telematics control unit to the bracket and includes
a band main body portion,
a loop portion connected to one end portion of the band main body portion, and
a locking portion connected to the other end portion of the band main body portion; and
a bolt that fixes the bracket to the internal combustion engine, wherein:
the bracket includes
a TCU support plate portion with which the telematics control unit is overlapped,
an attachment plate portion that projects from the TCU support plate portion toward one side in the horizontal direction and includes a bolt hole, and
a locking plate portion connected to the TCU support plate portion;
the telematics control unit is sandwiched between the TCU support plate portion and the band main body portion with the attachment plate portion inserted into the loop portion and with the locking portion detachably locked to the locking plate portion; and
the bolt fastens the attachment plate portion to the internal combustion engine through the bolt hole with the attachment plate portion of the bracket inserted into the loop portion and with the loop portion located between the bolt hole and the TCU support plate portion.

9. The engine assembly according to claim 1, further comprising a non-conductive elastic body sandwiched between the bracket and the telematics control unit with the telematics control unit spaced apart from the bracket, wherein:
the bracket includes a metal bracket including a TCU support plate portion with which the telematics control unit is overlapped;
the TCU support plate portion includes
a first support plate portion which extends in the vertical direction and with which the telematics control unit is overlapped in the horizontal direction,
a second support plate portion that is bent and projects from the first support plate portion, and
a third support plate portion that is bent and projects from the first support plate portion; and
the elastic body is located, in a bent state, along a corner portion between the first support plate portion and the second support plate portion, and is located, in a bent state, along a corner portion between the first support plate portion and the third support plate portion, such that the elastic body is located in: (i) a first gap between the first support plate portion and the telematics control unit; (ii) a second gap between the second support plate portion and the telematics control unit; and (iii) a third gap between the third support plate portion and the telematics control unit.

10. The engine assembly according to claim 1, further comprising:
a diagnostic communication line for a diagnostic tool connected to the ECU;
a branch communication line extending from the diagnostic communication line; and
a branch connector connected to the branch communication line, wherein:
the telematics control unit includes
a TCU main body including a circuit board,
a TCU communication line led out from the TCU main body, and
a TCU connector connected to the TCU communication line; and
the TCU connector is coupled to the branch connector.

11. A work machine comprising:
a frame;
equipment supported by the frame; and
an engine assembly supported by the frame, wherein:
the engine assembly includes
an internal combustion engine including
a crankshaft extending in a vertical direction,
at least one cylinder extending in a horizontal direction relative to the crankshaft, and
a crankcase accommodating the crankshaft,
an ECU including processing circuitry configured to control the internal combustion engine,
a bracket fixed to the internal combustion engine, and
a telematics control unit that is attached to the bracket and communicable with the processing circuitry; and
the telematics control unit is located between the internal combustion engine and the equipment in a front-rear direction of the work machine.

12. A work machine comprising:
a frame;
equipment supported by the frame;
an internal combustion engine supported by the frame;
an ECU including processing circuitry configured to control the internal combustion engine; and
a telematics control unit that is communicable with the processing circuitry, wherein
the telematics control unit is located between the internal combustion engine and the equipment in a front-rear direction of the work machine.

13. The work machine according to claim 12, wherein the equipment includes a control platform or a seat on which a user is seated, the control platform including an operating portion operated by the user.
